(19) United States
(12) Patent Application Publication
(10) Pub. No.: US 2023/0325813 A1
(43) Pub. Date: Oct. 12, 2023

(54) System and Method for Mining Crypto-Coins

(71) Applicant: Daniel Joseph Lutz, San Marcos, CA (US)

(72) Inventor: Daniel Joseph Lutz, San Marcos, CA (US)

(21) Appl. No.: 17/706,228

(22) Filed: Mar. 28, 2022

(51) Int. Cl. G06Q 20/36

(52) U.S. Cl. CPC G06Q 20/367; G06Q 2220/00

(57) ABSTRACT

The invention discloses a system for mining crypto-coins having a user module to facilitate connection of one or more miners for mining crypto-coins. Further, the system includes a blockchain network to facilitate communication between the user module and a Proof of Activity Mining (PoAM) module. The PoAM module is configured to generate crypto-coins based on transactions performed by the one or more miners. Further, the PoAM module includes a transaction module to allow mining of a pre-defined number of crypto-coins per transaction, a block module to allow mining of a block after a pre-defined number of transactions, a miners percentage module to determine a percentage of mined crypto-coins associated with the one or more miners per mined block and a halving module configured to half a number of coins per block and a number of coins per transaction after a pre-defined number of blocks are mined.

### CROSS-REFERENCE TO RELATED APPLICATION

This disclosure claims the benefit of the priority of U.S. Provisional Patent Application No. 63/167,536 entitled “Proof-of-Activity “PoA” model for mining cryptocurrency, integrates blockchain technology with a business’s activities that are deemed good for that business are assigned points and awarded to the miners that performed the good activities, and each point that received represents a share of the mined cryptocurrency, that these points represent the proof-of-activity that this a measure of value that is reflected in the market, as the proof-of-work of Bitcoin creates value on the market exchanges” and filed on Mar. 29, 2021. The above-identified application is incorporated herein by reference in its entirety.

### FIELD OF THE DISCLOSURE

This invention generally relates to crypto-currency and is more particularly related to a system and method for mining crypto-coins.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognised in the prior art. The subject matter in the background section merely represents different approaches, which in and of themselves may also correspond to implementations of the claimed technology.

Crypto-currency is a currency that exists digitally and uses cryptography to secure transactions by using a decentralised system to record transactions and issuing new units. Over the years, many crypto-currencies have been introduced in the market but most of them do not hold value in the markets. Such crypto-coins gained acceptance through the marketing campaigns and once the marketing ends, their value is lost due to lack of substance behind the coins.

One of the valuable crypto-currency in the market is Ethereum, an open-source project that introduced “Smart Contracts” as a unique innovation which placed Ethereum highly in crypto markets. Similarly, TRON, a clone of Ethereum works on an improved consensus algorithm that processes hundreds of times faster than Ethereum. Consequently, TRON processes at least 30% more transactions than Ethereum and may enter the top 10 spots on the markets as Ethereum has tapped out its bandwidth processing at 600 thousand transactions per day. Further, Bitcoin mining model created value from a proof of work concept that implies value in the activities making Bitcoin translate to increased value on the crypto-market.

It may be noted from the various crypto-currencies available in the market that a crypto-currency is valued in the market based at least on three important utility, scarcity and perceived value. Utility implies that the coins must have a vital function (or use-case) to incentivise people to hold on to the coin and the coin’s value connects to its Utility such that the more uses the coin has, the more value. The highest Utility for a coin is when the coin is used as a “medium of exchange,” allowing it to be swapped for goods and services. Further, scarcity implies to the finite nature of the coins’ total supply possible in circulation such that a fixed supply of a coin will have its value increased over time. Therefore, when there is only a limited supply of coins in circulation, and the demand increases, the resulting increase in value is due to Scarcity. Furthermore, Perceived Value implies coin is only as valuable as the markets deem it to be such that the market perceived value of any coin will depend on core factors to develop the unique project that fills a need. Therefore, projects that persistently achieve the milestones that are predicted will gain Perceived Value.

Therefore, the crypto-currencies may be introduced by the businesses to enhance the business performance by rewarding people active in building business values in the business such as, business staff, customers, distributers, retailers or anyone that does anything to create what a business deems as favourable to the growth of the business. Further, this rewarding may lead to positive effect in the value of the introduced crypto-coins. Thus, there is a need for a mechanism for mining crypto-coins that fulfils the above-mentioned requirements.

### OBJECTIVES OF THE INVENTION

It is an objective of the invention to provide a mechanism for mining crypto-coins effectively.

It is another objective of the invention to provide the crypto-coins that have high utility.

It is yet another objective of the invention to provide the crypto-coins that have high scarcity.

It is yet another objective of the invention to provide the crypto-coins that have high perceived value.

It is yet another objective of the invention to provide a mechanism to mine crypto-coins that is transactions of real world goods and services and online goods and services based.

It is yet another objective of the invention to provide a mechanism to mine crypto-coins that halves the number of crypto-coins per block after a pre-defined number of blocks.

It is yet another objective of the invention to provide a mechanism to mine crypto-coins that allows the miners to hold coins in the wallet for increased value.

### SUMMARY

The present invention discloses a system for mining crypto-coins. The system includes a user module to facilitate connection of one or more miners for mining crypto-coins and a blockchain network to facilitate communication between the user module and a Proof of Activity Mining (PoAM) module. The PoAM module is further configured to generate crypto-coins is based on activities performed by the one or more miners that add to the total. The PoAM module includes a transaction module to allow mining of a pre-defined number of crypto-coins per transaction, a block counter to allow mining of a block after a pre-defined number of transactions, a miners percentage module to determine a percentage of mined crypto-coins associated the one or more miners per mined block. Further, the PoAM module includes a halving module configured to half at least one of: a number of coins per block and a number of coins per transaction after a pre-defined number of blocks are mined.

In an embodiment of the present invention, the system further includes a database communicatively coupled to the PoAM module and configured to store at least one of: the unmined crypto-coins and information associated with the mined crypto-coins. The total number of crypto-coins are 21000000. In an embodiment of the present invention, the number of coins may vary depending on the business the PoAM may be used for.

In an embodiment of the present invention, the PoAM module further includes an activity factor module that is configured to move 5 percent swing per block of the mined coins from the miner side to the operation side and back again based on an activity factor. It may be noted that the swing amount may be other than 5 percent a percentage or could be a fixed amount of coin for the swing amount per block may be without departing from the scope of the invention.

In an embodiment of the present invention, the PoAM module also includes a wallet staking module that is configured to facilitate the miner to hold the mined coins and return staking points and multiply the staking points by at least two multipliers count-multi and stake-multi.

In an embodiment of the present invention, the activity factor is determined by change of the volumes ratios between the product sales and the coin sales of the previous block to the current block. The blockchain network is further configured to host the crypto-coins for the one or more miners.

In an embodiment of the present invention, the pre-defined number of crypto-coins per transactions are 50 crypto-coins. The pre-defined number of transactions are 2100 transactions. The pre-defined number of blocks are 100 blocks. In an embodiment of the present invention, the pre-defined number of crypto-coins per transactions, pre-defined number of transactions and pre-defined number of blocks may be different from the aforementioned numbers without departing from the scope of the invention and based on the requirements of the business. Further, applied for 1 coin from the business such that premined coins when applied to other coins may not have premined coins.

An embodiment of the present invention discloses a method for mining crypto-coins. The method includes facilitating connection of one or more miners for mining crypto-coins and facilitating communication between the user module and a Proof of Activity Mining (PoAM) module. Further, the method includes generating crypto-coins based on activities performed by the one or more miners that add to the total. The generation of crypto-coins is performed by allowing mining of a pre-defined number of crypto-coins per transaction, allowing mining of a block after a pre-defined number of transactions and determining a percentage of mined crypto-coins associated with one or more miners per mined block. Further, the method includes halving at least one of: a number of coins per block and a number of coins per transaction after a pre-defined number of blocks are mined.

In an embodiment of the present invention, the method includes storing at least one of: the unmined crypto-coins and information associated with the mined crypto-coins in a database. The total number of crypto-coins are 21000000. In an embodiment of the present invention, the number of coins may vary depending on the business the PoAM may be used for.

In an embodiment of the present invention, the method further includes moving 5 percent swing per block of the mined coins from the miner side to the operation side and back again based on an activity factor. It may be noted that the percent of swing per block may be other than 5 percent without departing from the scope of the invention.

Further, the method includes facilitating the miner to hold the mined coins and return staking points and multiply the staking points by at least two multipliers count-multi and stake-multi.

In an embodiment of the present invention, the activity factor is determined by change of the volumes ratios between the product sales and the coin sales of the previous block to the current block. Further, the method includes hosting the crypto-coins for the one or more miners via a blockchain network.

In an embodiment of the present invention, the pre-defined number of crypto-coins per transactions are 50 crypto-coins. The pre-defined number of transactions are 2100 transactions. The pre-defined number of blocks are 2600 blocks. In an embodiment of the present invention, the pre-defined number of crypto-coins per transactions, pre-defined number of transactions and pre-defined number of blocks may be different from the aforementioned numbers without departing from the scope of the invention and based on the requirements of the business. Further, applied for 1 coin from the business such that premined coins when applied to other coins may not have premined coins. Further, applied for 1 coin from the business such that premined coins when applied to other coins may not have premined coins

Thus, the disclosed mechanism for mining crypto-coins allows effective mining of the crypto-coins. Further, the disclosed crypto-coins have high utility, high scarcity and high perceived value. The disclosed mechanism to mine crypto-coins is transactions based and provides a better valuation of the business. Further, the disclosed mechanism halves the number of crypto-coins per block after 100 block mining to increase scarcity of coins in the market. It may be noted that the disclosed mechanism may half the number of crypto-coins per block after any number of block mining without departing from the scope of the invention. The disclosed mechanism allows the miners to hold the coins in the wallet allows increase in the value of the coins. Therefore, the disclosed mechanism for mining crypto-coins allows high value of the crypto-coins in the market.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a block diagram of a system for mining crypt-coins in accordance with an embodiment of the present invention;

FIG. 2 illustrates a flow chart of a method for mining crypto-coins in accordance with an embodiment of the present invention;

FIG. 3A illustrates Golden ratio swing chart in accordance with an embodiment of the present invention;

FIG. 3B illustrates Fibonacci Transition points in accordance with an embodiment of the present invention;

FIG. 4 illustrates coin disbursement may be between miner’s side and operation’s side in accordance with an embodiment of the present invention;

FIG. 5 illustrates an NFT club with 1% of mine allocation in accordance with an embodiment of the present invention.

FIGS. 6A, 6B and 6C illustrates Stake Wallet Example table in accordance with an embodiment of the present invention.

FIG. 7 shows crypto-coins mining disbursement halving chart table in accordance with an embodiment of the present invention.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described

Embodiments of the present disclosure will be described more fully hereinafter with reference to the accompanying drawings in which numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

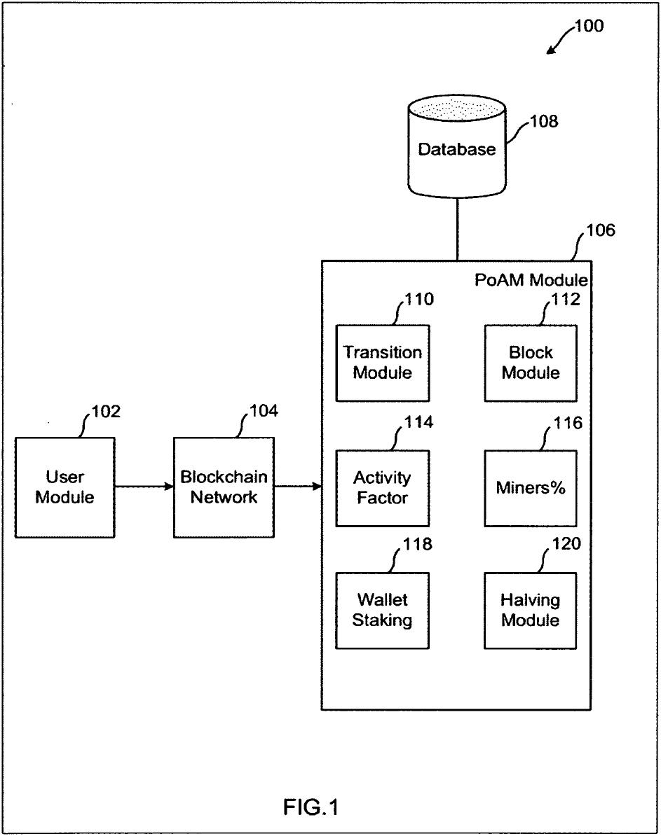

FIG. 1 illustrates a block diagram of a system for mining crypt-coins in accordance with an embodiment of the present invention. In an embodiment of the present invention, the system 100 may include a user module 102, a blockchain network 104, a Proof of Activity Mining (PoAM) module 106 and a database 108. Further, the PoAM module 106 may include a transaction module 110, a block module 112, an activity factor module 114, a miners percentage module 116, a wallet staking module 118, and a halving module 120.

In an embodiment of the present invention, the system 100 may be based on an activity reward value model for value creation for a business that is a PoAM model to value activities and provide rewards from the mining power generated from those activities valued by the business. Further, the crypto-coin’s integration of coin mining into the operation of the business may create a symbiotic relationship between the coin’s value on crypto markets and the value of entire business such that, ”what is positive for the business is positive for the coin. What is positive for the coin is positive for the business.“ Thus, integration may be through algorithms that reflect “what is positive for the business”. In an embodiment of the present invention, the happiness of the Members, Reaching Goals Milestones, Business Activities, Member Growth, Member activity, and Sales Volumes are but a few of many positive activities that the algorithms use. In an embodiment of the present invention, the crypto-coin represents the created “True Value” for the coin holders and having utility, scarcity and perceived value via a unique coin model called PoAM.

In an embodiment of the present invention, the user module 102 may be configured to facilitate connection of one or more miners for mining crypto-coins. In an embodiment of the present invention, the system 100 may be configured to store the crypto-coins in the database 108 having a fixed number of coins. In an embodiment of the present invention, the fixed number or the total number of coins in the database may be 21000000 or 21 Million divided into one or more blocks. In an embodiment of the present invention, the number of coins may vary depending on the business the PoAM may be used for. Further, initially the system 100 may be configured to release 50 coins per transaction and each block may be mined via 2100 complete transactions. Therefore, initially each block may include 105000 coins. It may be noted that without departing from the scope of the invention, the system may release any number of coins per transactions and each block may be mined via any number of complete transaction based on the needs and requirements of the business. Similarly, initially each block may include any number of coins based on the requirement of the business. In an embodiment of the present invention, the system 100 may release crypto-coins associated with 1 coin from the business such that premined coins when applied to other coins may not have premined coins . The one or more miners may be customers of a business or any other person having access to the crypto-coins.

In an embodiment of the present invention, a blockchain network 104 may be configured to facilitate communication between the user module and PoAM module 106. Further, the blockchain network 104 may be configured to host the crypto-coins for the one or more miners. In an embodiment of the present invention, the system 100 may utilise one or more blockchain network known in the art.

In an embodiment of the present invention, the PoAM module 106 may be communicatively coupled to the database 108. It may be noted that the database 108 may be configured to store the unmined crypto-coins, information associated with the mined crypto-coins or a combination thereof. Further, the PoAM module 106 may be configured to a PoAM model may reward the one or more miners based on all activities that add points to the total and only transaction activity go towards end a block of mining. In an embodiment of the present invention, the activities may include transaction activities of a business measured as sales volume from the business product sales and Miner activities deemed by the business management to have a positive value to the business excluding corrective and negative activities. Further, the PoAM model may be configured to create value in the business based on utility, scarcity and perceived value of the coins in the market.

In an embodiment of the present invention, the PoAM module 106 may utilise at least one of activity utility value, activity scarcity value (by capping the total coins and halving event after a predefined number of mined blocks), activity reward points system and activity perceived value.

In an embodiment of the present invention, the transaction module 110 may be configured to allow mining of a pre-defined number of crypto-coins per transaction. Initially, the pre-defined number of crypto-coins per transactions may be 50 crypto-coins, such that one transaction may generate 50 crypto-coins out of the total coins. However, the pre-defined number of crypto-coins per transactions may be other than 50 depending the requirements of the business.

In an embodiment of the present invention, the block module 112 may be configured to allow mining of a block after a pre-defined number of transactions. Further, the pre-defined number of transactions may be 2100 transactions. It may be noted that the pre-defined number of transactions may be other than 2100 without departing from the scope of the invention.

In an embodiment of the present invention, the activity factor module 114 may be configured to move 5 percent swing per block of the mined coins from the miner side to the operation side and back again based on an activity factor. It may be noted that the percent of swing per block may be other than 5 without departing from the scope of the invention. Further, the activity factor is determined by change of the volumes ratios between the product sales and the coin sales of the previous block to the current block. Thus, the activity factor is regulator that may modify the release of the coins from one block to the next.

In an embodiment of the present invention, the activity factor module 114 may determine that the difference in volume between the sales of products and sales of coins from one block to the next may increase or decrease naturally as part of a rhythm of the business. Therefore, the activity factor may be used to adjust or weight the coin distribution between the miners and operation by modulating the distribution of the coins in a stable and balanced way. The activity factor may be calculated by comparing product sales and coin sales on an exchange, Decentralised Exchange (DEX), or liquidity swap. Further, the activity factor module 114 may calculate the activity factor and may compare the result using Fibonacci “Golden Ratio Swing” table and chart to determine the direction of flow of X% Swing Amount:

| | |
|---|---|
| -∞ to -1.619 | - X% |
| -1.618 to -0.619 | + X% |
| -0.618 to <0 | - X% |
| +0 to +0.618 | + X% |
| +0.619 to +1.618 | - X% |
| +1.619 to +∞ | + X% |

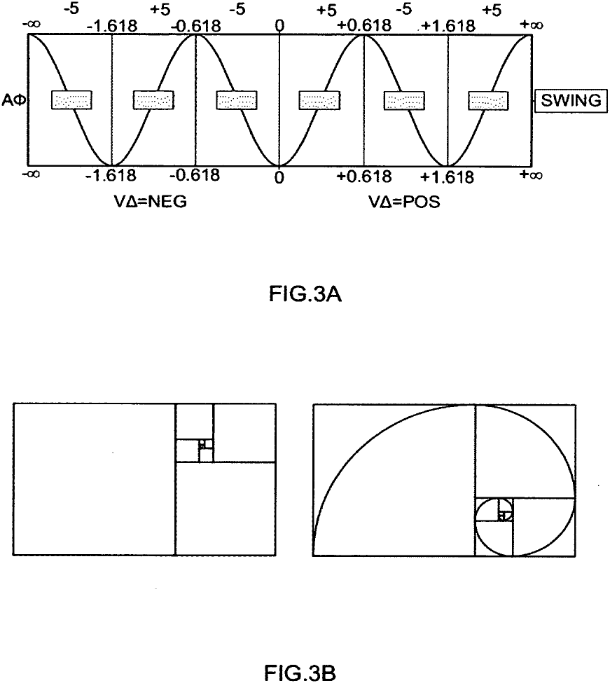

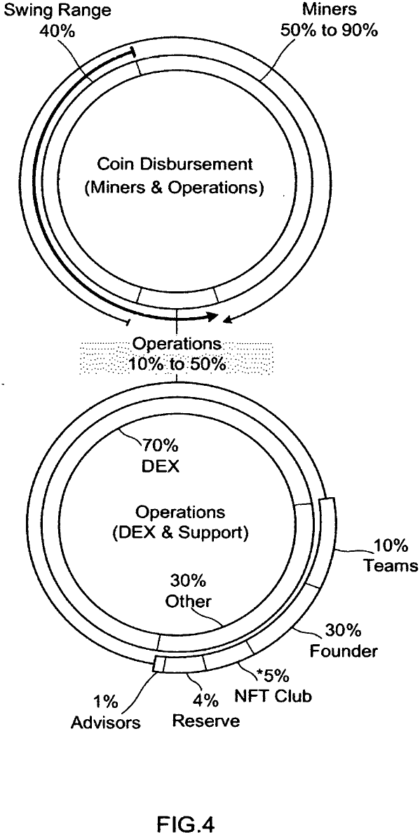

The activity factor may fall onto one of six ones on the Golden Ratio Swing Chart, as shown in FIG. 3A. Further, FIG. 3B may illustrate Fibonacci transition points, in accordance with an embodiment of the present invention. In one embodiment of the present invention, if the activity factor falls under green area, then a swing of plus 5% is added to the miner’s side. In another embodiment of the present invention, if the activity falls under red area, then a swing of minus 5% is subtracted from the miner’s side.

Calculating the Activity Factor: The calculations needed to determine the Activity Factor are:
1. P%Δ- “Product Percent Change” in sales volume from Block to Block, for the Business “Product Sales.”
2. C%Δ- “Coin Percent Change” in sales volume from Block to Block, for the DEX “Coin Sales.”
3. S- Shift (S) value ensures that when this value is added to ether P%Δ or C%Δ that the value is positive and are calculated by adding the absolute value of both P%Δ and C%Δ together and for the case when ether P%Δ or C%Δ is zero by adding one (+1) makes sure the value is above zero.
4. Shifted P%Δ- Shift value (S) is added to P%Δ for a Volume Percent Difference result above zero.
5. Shifted C%Δ- Shift value (S) is added to C%Δ for a Volume Percent Difference result above zero.
6. V%δ- The Volume Percent Difference (V%δ) formula works with positive numbers greater than zero, thus adding the Shift (S) value to the values of P%Δ and C%Δ, thereby shifting the results into the positive. The “Volume Percent Difference” in the ratio from Block to Block, for the, shifted Volumes “Percent Change in Product Sales” (P%Δ) and “Percent Change in Coin Sales” (C%Δ).
7. VΔ- “Difference” between the two ratios, “Business Sales” and the “Coin Sales,” may determine what direction the 5% change may go. The larger of the two numbers set the swing direction as a Positive (POS) or Negative (NEG) side of the zero “0” on the Golden Ratio Swing Chart.

### Formulas for the Activity Factor

$$\text{Percent Change "\%} Δ \text{" =} \left(\left(\text{B - A}\right) / \text{A}\right) \times 100$$

It may be noted that only the decimal number may be required for the calculations for “Percent Change,” so multiply by 100 not needed and “x 100” from all the following formulas may be dropped. Thus,

$$\text{PoAM Percent Change = \%} Δ = \left(\text{B - A}\right) / \text{A}$$

Further, the volumes for both Products and Coin sales channels from both sides from block to block may be needed and thus, applying the PoAM’s Percent Changes formula.

$$\text{P\%} Δ \text{= Business Product Side Percent Change}$$

Where,
Product Percent Change (P%Δ) is the change in Product Sales volume from the previous block to the current block.
Block-A “Previous Block” Product Volume = ProductA
Block-B “Previous Block” Product Volume = ProductB

Next, solving for Product Volume Percent Change “P” of the ratio between the volume of Product Sales for the Previous Block to the Current Block.

$$\text{P\%} Δ \text{=} \left(\text{ProductB - ProductA}\right) / \text{ProductA}$$

$$\text{C\%} Δ \text{= DEX Side Percent Change}$$

Where,
Coin Percent Change (C%Δ) of the volume of Coin Sales from the previous block to the current block.
Block-A “Previous Block” Coin volume = CoinA
Block-B “Previous Block” Coin volume = CoinB

Next, solving for Coin Volume Percent Change “C” of the ratio between the volume of Coin Sales for the Previous Block to Current Block.

$$\text{C\%} Δ \text{=} \left(\text{CoinB - CoinA}\right) / \text{CoinA}$$

V%δ = Volume Percent Difference. Next, the two sales channels of Products and Coins from the previous block to the current block may be compared by finding the Percent Difference between their Percent Change of Volumes of Products (P%Δ) and Coins (C%Δ). Percent Difference Formula:

$$\left(\% δ\right) = \left(\left|\text{n1} - \text{n2}\right| / \left(\text{n1} + \text{n2} / 2\right)\right) \times 100$$

It may be noted that only the decimal number may be need for the calculations for “Percent Difference,” so there is no need to multiply by 100 and drop the “x 100” from all the following formulas. PoAM Volume Percent Difference Formula:

$$\text{V\%} δ \text{=} \left(\left|\text{P\%} Δ \text{- C\%} Δ\right|\right) / \text{C\%} Δ$$

Shift into the Positive:- The Percent Difference Formula requires all numbers to be greater than zero, and so Shift all Percent Change formulas for Products and Coin by adding the both together and adding that result to both individually and then adding one.

$$\begin{matrix}\text{Shift Amount = S =} \left(\left|\text{P\%} Δ\right| + \left|\text{C\%} Δ\right|\right) + 1 \text{NewP\%} Δ \text{= S + P\%} Δ \text{=} \\ \text{SP\%} Δ \\ \text{NewC\%} Δ = \text{S + C\%} Δ \text{= SC\%} Δ\end{matrix}$$

$$\text{V\%} δ \text{=} \left(\left|\text{NewP\%} Δ \text{- NewC\%} Δ\right|\right) / \text{C\%} Δ$$

Note: The V%δ shows the ratio between the Product and Coin volumes of the previous block to the current block. This number may range from 0.00 to infinity, limiting the result to 2.00.

$$\text{V} Δ \text{= Greater Change in Volume Sets the Direction}$$

The “Difference” between the (P%Δ) and (C%Δ) may yield a positive or negative value. This value determines the trend towards the Sales of Products verse Sales of Coin.

$$\text{P\%} Δ \text{- C\%} Δ \text{= V} Δ \text{or -V} Δ \text{= POS or NEG}$$

Activity Factor (AΦ): The change of the volumes ratios between the Product Sales and the Coin Sales of the previous block to the current block now sets the 5% swing in coin allocation for this completed mining Block.

$$\text{A} Φ \text{=} \left(\text{V\%} δ \times \text{V} Δ\right) / \left|\text{V} Δ\right|$$

In an embodiment of the present invention, the marked analysis may be performed by the two sales channel by comparing the crypto-coin value. In order to do so, the system may monitor total sales volume of products and coins for each completed Mined Block and if the value increases block to block, then the number of Sales of the Business products would reflect more value change to the business and is demonstrated by the market price rises of crypto-coin on the DEX. Further, if there is a larger sales volume, more crypto-coin is mined and sent to the DEX to supply crypto-coin to the market

Further, the system 100 may chart the overall business value of the business and the crypto-coin from one block to the following block by the Block Power Number (BP). The volume per coin number will reflect the value of the business activity used to Mine the coin as the “Power of the Block” and directly reflects how well the business is doing from one block to the next. Further, the Total Sales Volume (TSV) per Mining Block is all Total Product Sales (TPS) from the First Transaction to the last (2,100), plus all the Coins Sales Volume (CSV) from the DEX in the current block. It may be noted that first transaction to the last may be other than 2100 without departing from the scope of the invention.

$$\text{TSV = TPS + CVS}$$

Further, Block Power (BP) is calculated by dividing the Total Sales Volume (TSV) from the business and crypto-coin by the Total Number of Coins (TNC) in that block.

$$\text{BP =} \text{TSV} / \text{TNC}$$

Further, halving effect may lead to increase of the block power value. At the completion of every halving event set of blocks, a Mining Halving Event may occur on the next block, and the effect on the Block Power is that the resulting value will double between the two blocks if the Total Sales Volume is the same. The effect is that the Scarcity of coins will increase the value, as follows:

$$\text{Halving Effect: BP =} \text{TSV} / \left(50 \% \times \text{TNC}\right) = 2 \times \text{BP}$$

In an embodiment of the present invention, the purpose of the PoAM system for mining coins is to link positive business activities with the release of mined coins that increase the value of coin on the market. Thus, the positive activity is rewarded by the assigning of “Positive Points”. The system has recognised two general activities that create value: Sales and Business Growth Activities. The sales activities have two different channels. One is of sale business products channel, and the other is the sales of the coin in the market The “Positive Activity” of sales is rewarded by coin. The goal is to increase the sales volume and reward that Activity.

In another embodiment of the present invention, The coin’s release is based on the Positive Activity of 2,100 product sales transactions. In an embodiment of the present invention, the number of product sales transactions may vary depending on the business the PoAM may be used for. Further, transactions show positive value in the business, but the reverse of a transaction is a real-life situation. A transaction can be cancelled, and the product may be returned. This reverse transaction is considered a “Negative Activity,” and to maintain that the “True Value” is reflected in the price of the coin, there needs to be a corrective action taken to rebalance the “Positive Points” previously given. When this occurs, “Corrective Points” are given to the Miner in the current block or the following block to rebalance the coin’s value by correcting the received unwarranted positive points.

Further, there may be other reasons that corrective Points are given to a miner, such as points given due to error or fraud, but those reasons should not be punitive. Points should not be used to force others into compliance with some goal. When points are used as punishment for activity, this punishment does not restore the balance of value in the coin. Instead, this action will result in a negative value attributed to the coin. Furthermore, the release of coins is triggered by-product sales. Once 2,100 transactions are reached, a block is closed, and coins are minted. Returns or charge-backs can, of course, offset these “positive” and value-adding activities. However, these returns or “negative” activities are minimised by reversing and adding a negative multiplier to the Miners original points within the current or next open block. This process minimises returns and increases the underlying value of the coin. Additionally, corrective points are given to handle negative activities and, where and when appropriate, apply these corrective points to the miner’s activity ledger. These corrective points are a gentle reminder that these types of activities may hinder the long-term growth and value of the coin. This process, although not draconian, is a subtle and constant reminder to the miners to keep transactions and activities within the program on a positive course.

In an embodiment of the present invention, the miners percentage module 116 may be configured to determine a percentage of mined crypto-coins associated the one or more miners per mined block. In an embodiment of the present invention, the miners percentage module 116 may configured to divide the total miner coins per block into miners and operation. The miners percentage may vary in a range of 50 to 90 percent and the operations percentage may vary from 10 to 50 percent. Other example miners percentage may vary in a range of 1 to 99.999 percent and the operations percentage may vary from 0 to 0.001 percent

In an embodiment of the present invention, the miners percentage module 116 may also determine miner’s mining points that have no monetary value represent the recognition of miner’s positive efforts for the business and receive Crypto-coin from Transaction Activities (TA) and Mining Activities (MA). Further, the Mining Activities may all contain any Corrective Points received by the Miner. Therefore, the Miner’s Mining Points (Points) may be calculated by adding Transaction Activities (TA) and Mining Activities (MA).

Miner’s Mining Points (Points) = Transaction Activities (TA) + Mining Activities (MA)

Calculate Miner’s Mining Power- Mining Power (MP) is equal to the Miner’s Mining Points (Points) multiplied by the Selected Mining Position (Position).

$$\text{Mining Power = MP = Points} \times \text{Position}$$

Total Global Mining Power- Miner’s Mining Power from all Miners is combined to calculate the Total Global Mining Power (Power).

$$\text{Power = "Miner\#1-MP" + "Miner\#2-MP" + "Miner\#3-MP" +} …$$

Coin Per Point- The Total Global Mining Power (Power) from all Miners is used to calculate the “Coin Per Point” (CPP) and is calculated by taking the Miner’s Side percentage of Crypto-coin (MS%) from the Block Split Range Table, and divided by the total Global Mining Power (Power) from all Miners in that block.

$$\text{CPP =} \text{MS\%} / \text{Power}$$

In an embodiment of the present invention, the wallet staking module 118 may be configured to facilitate the miner to hold the mined coins and return staking points and multiply the staking points by at least two multipliers count-multi and stake-multi.

In an embodiment of the present invention, a Market On Boarding System (MOBS) may be used to determine what the starting price crypto-coin will start trading at on the market by letting the Miners determine that market price through their purchases of crypto-coin. The price of each successive set of 100 crypto-coin will increase after each Transaction. Thus, the system 100 may let miner’s purchases set the market price and so it is all up to miners to decide what the starting price will be. In an embodiment of the present invention, the crypto-coin will enter the market on a decentralised exchange at a price that is determined using the Market On-Boarding System to set the price. This positive activity is rewarded by MOBS Points being given for each Catch of 100 crypto-coin purchased. In an embodiment of the present invention, the positive activity may be rewarded by MOBS Points for Catch of any number of crypto-coins purchased based on the business the PoAM may be used for. This activity is shown to have a greater reward for after each Catch is sold, to the miners as an individual and as the group of Miners by the MOBS Points becoming larger as the price increases as well as the points are multiplied by the number of Catches individually purchased by a Miner.

In an embodiment of the present invention, the MOBS may increase the perceived value of the crypto-coins because the purpose of MOBS is to set the market price that crypto-coin will enter on an exchange at and since the price is only increasing as each Catch is sold, the perception is the crypto-coin value is increasing as someone is willing to pay at least the last price. Further, the rules for the MOBS may be as follows:
All transactions are swapped for crypto-coins.
Starting price may without any limitation be 0.1 TRON.
They are sold in a bundle of a required number of Coin such as, 100 PoAM Crypto-Coin at a time, which we call a Catch.
After each Catch sale, the price will increase by, without any limitation, 0.1 TRON per PoAM Crypto-Coin.
Day’s Counter, such as, without any limitation, ten day counter will begin at the beginning of the Catch Sales.
Five Minute Counter begins after each Catch sale before the following Catch becomes available.
There is no limit to the number of “Catches” one can buy.
Crypto-coins are sent into the Miner’s MOBS wallet.
Crypto-coins purchased through MOBS will be locked in until the closing of the pre-set number of block, such as without any limitation 15th block.
Unlocked Crypto-coins may also be sent to the Miner’s business crypto coin wallets.
MOBS Coins in the Miners’ MOB wallets may be transferred to other Miner’s MOBS wallets.
Day’s Counter reaches zero, the final MOBS PoAM Crypto-Coin price will be set to the last Catch price sold.
The Catch will continue to be sold without further price increases until the DEX launches.
The MOBS Price is the starting price of PoAM Crypto-Coin on the new DEX.
The Market On-Boarding System ends when the DEX launches.
The remaining mined PoAM Crypto-Coin not sold will be available on the DEX for sale initially at the final MOBS Price.
Once PoAM Crypto-Coin launches on the DEX, the market price will follow the market.

In an embodiment as shown in FIG. 4, coin disbursement may be between miner’s side and operation’s side. Further, the each side swing range percentage may vary in an range of 0-40% from block to block 0-5% following the Golden Ratio Swing Amount, as determined by activity factor and the minimum and maximum side disbursement boundaries. Further, miner’s side will range from minimum 50% and a maximum of 90% of all mined coins. Furthermore, the operations side will range from a minimum of 10% and a maximum of 50% of all mined coins. In an embodiment of the present invention, the miner’s side and the operations side may vary depending on the business the PoAM may be used for. In one example, the operations side may, without any limitation, be allocated from the 100% received from the disbursement to the operation’s side and the crypto-coin is further allocated into two categories of decentralised exchanged that receive 70% and 30% support. The support is divided into 10% teams (5% business and 5% crypto-coin teams), 10% founders, 5% NFT club where there are five 1% NFTs that will receive 1% of all crypto-coin distributed to operations, 4% to a reserve and 1% to advisors.

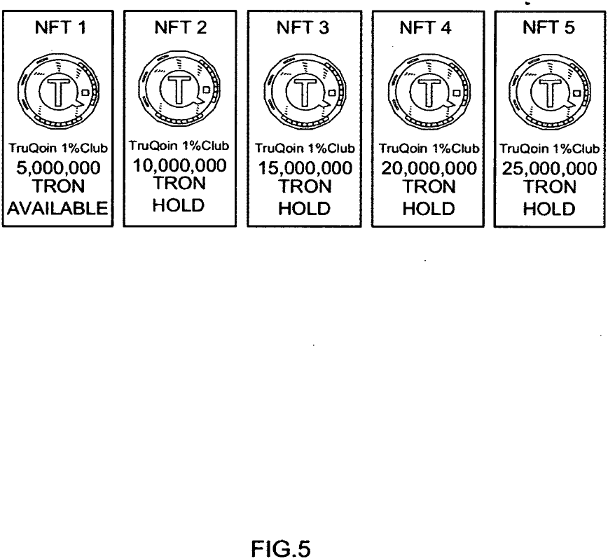

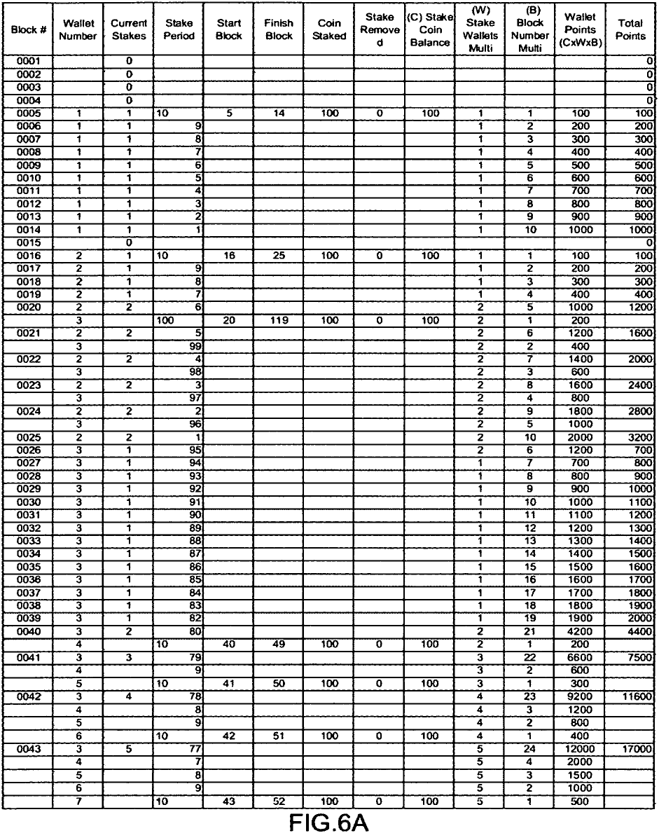

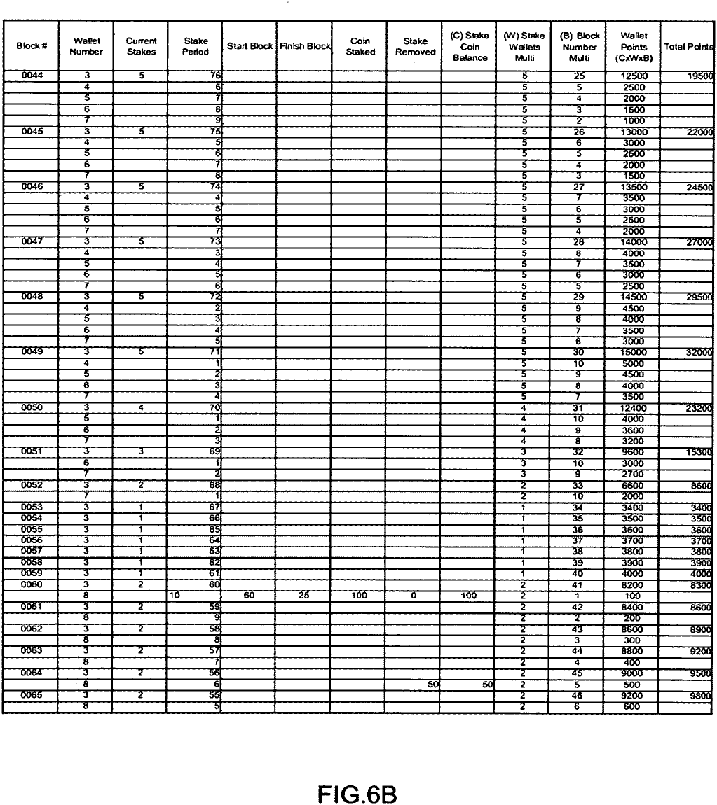

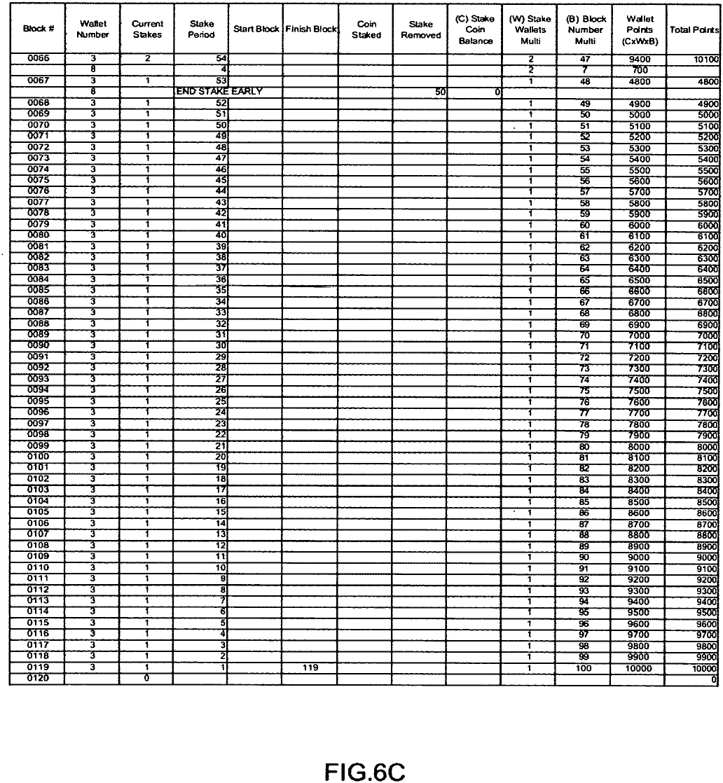

In an embodiment of the present invention, at the close of each block, crypto-coin is mined and divided between two channels- miner’s side and the operation side. Further, one percent of all operations coins are made available to five different NFTs and once purchased may flow to that designated wallet until the last block for example, without any limitation, number 2600 is mined. Thus, for the exemplary scenario, the cost of the first NFT (1% slot) is 5 million TRON (5,00,000 TRX) and will increase by 5 million TRX for each NFT after that, as shown in FIG. 5. It may be noted that the aforementioned numbers may vary based on the requirements of the business. Further, there may be not limit to the number of NFTs a miner can acquire.

Staking PoAM Crypto-coin for Points- Miners of Crypto-coin are allowed to “Stake” their Crypto-coin for mining points. When a Miner stakes their Crypto-coin, they hold those coins in a Staking Wallet In return, the Miner receives Staking-Points based on how many Crypto-coin are on hold in the Staking Wallet at the close of each Block and multiplied by two multipliers; Count-Multi and Stake-Multi. The Staking Wallets functions by allowing the Miner to move Crypto-coin in the Miners’ mining wallet “My Wallet” to a Stake account for a specific number of blocks. The Miner has a one-time option per each Block to “Stake” any amount of coin they want for a period of, without any limitation, ten (10) blocks, one hundred (100) blocks, or both. The more coin and the longer the coin are held across blocks, the higher the multiplier or reward may be at the end of each Block.

In an embodiment of the present invention, the disclosed crypto-coin’s mining wallet has the ability for a miner to stake crypto-coin for 10 or 100 Blocks, and the miner will receive “Staking Points” for each staking wallet the miner has and for each Block the miner’s crypto-coin is staked. It may be noted that the aforementioned numbers may be understood as examples and may vary based on the requirements of the business without departing from the scope of the invention. This staking point activity is shown to have a greater reward as after each block the staking points become larger, as well as the points are multiplied by the number of active stake wallets a Miner. Further, the miners can do many activities that will be positive for the business, including participating in the decentralised Autonomous “DAO” Community and any activity to build the business and crypto-coin business eco-system. The points rewards are not limited and all activities can be integrated into the Miner Activity Points.

Increase PoAM Crypto-Coin Value through Scarcity- The Scarcity of Crypto-coin can increase by creating an incentive to hold Crypto-coin off-market. The greater the amount of Crypto-coin held off-market, and the longer Crypto-coin is withheld from the marketplace, the greater the effect of scarcity on the value of Crypto-coin. Increased scarcity is accomplished by the Staking Points System, where Crypto-coin is held off-market in Staking Wallets through incentive point rewards to keep the Crypto-coin off-market, which increases the price through scarcity. The longer, the better, so by increasing the enticement for Staking Points to receive more Crypto-coin, the longer Crypto-coin is staked.

Staking Ideal Situation- The longer the coin is staked, the amount of Points increases. So the incentive for continuing to keep the Crypto-coin staked is by multipliers that increase after each Block Reward. If any number of Crypto-coin is removed from the Stake, then no points are given for the Crypto-coin removed. Only points for the Crypto-coin that remains in the Staking Wallet are given. Since the multipliers effect increases each Block, the total Crypto-coin that remains in the Stake is counted, so essential not to remove Crypto-coin to receive the highest reward points.

In an embodiment of the present invention, the rules for staking wallet may include adding to a staking wallet once per Block from the mined coin received, new stake wallets appear at the start of a new block, since multiple stakes are set up, keep the ALL stakes running by adding the 2nd Multi of the numbers of currently running stakes and using the two Multipliers, Count-Multi and Stake-Multi, for increasing the Crypto-coin value by keeping the coins staked.

Staking Points Formula ( Staked-Coin X Count-multi X Stake-multi )-The Points are calculated for each Staked Wallet a Miner creates, and the points are added to the Miner’s total points for each Block mined. The Points are calculated by the amount of Crypto-coin the Miner staked in a Stake-10 or Stake-100 wallet, which is multiplied by two multipliers (Count-Multi and Stake-Multi).

Count-Multi- Count-Multi is a points multiplier based current number of blocks the Stake has been active. For example, a Stake-10 Wallet may have its Count-Multi increase from 1 to 10, starting on the first Block the Crypto-coin is Staked in the Stake-10 wallet and increase to 10. A Stake-100 Wallet may have its Count-Multi increase from 1 to 100.

Stake-Multi- Stake-Multi is a points multiplier based current number of Stakes that are currently active. For example, if the Miner stakes Crypto-coin in a Stake-100 Block wallet for each Block over 20 blocks, then Stake-Multi may be increase by one each time Stake Wallet starts, and the Stake-Multi may be 20 on the last Block. Any Stake Ended by moving ALL Crypto-coin back to the Mining Wallet; no points for that Block and Stake-Multi may decrease by 1. The Miner can have a Maximum Stake-Multi of 100 because the Longest running Stake Wallet is 100, and the Miner would have to Stake every Block for 100 Blocks to reach a Stake Multi of 100 and continue to stake every Block after that to keep a Stake-Multi of 100 active. Further, the features may include:
a.i.1. Stake any amount of (available) coin from Miner’s My Wallet
a.i.2. Receive Points reward for Staking
a.i.3. End Stake at any time by moving ALL crypto-coins back to the Mining Wallet. (No points for that Block)
a.i.4. Keep In Stake to End of Stake to maximise all Points Stake for 10 or 100 Blocks, or both per Block Crypto-coin can Stake only one time per Block.
ai5. Points are given at the end of each Block.
a.i.6. Only Crypto-coins from the Mining Wallet can be Staked.
a.i.7. At the end of a Staked Wallet, the Crypto-coin is moved back to the Mining Wallet

Two Stake Wallets- In an example, the two stake wallets may, without any limitation, be Stake 10 Wallet and Stake 100 Wallet

Stake Points- Stake for Points for each Block, the number of Crypto-coin is staked times both multipliers (Count-Multi and Stake-Multi).

Stake Wallet Points- Each Stake Wallet Started may gain points until the Stake period is over or all the Crypto-coin are removed from the Stake Wallet.

Stake Wallet Naming Convention- A Stake Wallet that may run for 10 Blocks is called a Stake-10 Wallet, and a Stake Wallet that may run for 100 Blocks is called a Stake-100 Wallet. For example, a Stake-10 Wallet Started on Block 0004 is named B0004-Stake-100.

$$\begin{matrix}\text{StakeWalletPoints =} \\ \text{NumberTRQstakedThisBlock} \times \text{Count-Multi} \times \text{Stake-Multi}\end{matrix}$$

It may be noted that the Stake-Multi starts to decrease at Block 0015 as the Stake-10 wallets complete. At Block 0026, the Stake-Multi is one, and assuming no other Stake Wallets are started, the Stake-Multi may stay one until the 100th Block at Block 0105. The highest number of points is given when the highest number of Stake Wallets are running.

Stake Block Points- A single Block may receive Points from up to 110 Stake Wallets that are running at the time the Block completes-the advantage of Staking as many Crypto-coin as possible for the longest stake period.

$$\begin{matrix}\text{Stake Block Points Formula =} \\ \text{StakeWalletPoints\_1 + StakeWalletPoints\_2 +} \\ \text{StakeWalletPoints\_3 + StakeWalletPoints\_N +} …\end{matrix}$$

In an embodiment of the present invention, the halving module 120 may be configured to half a number of coins per block, a number of coins per transaction after a pre-defined number of blocks are mined or a combination thereof. Further, the pre-defined number of blocks may be 100 blocks. The reduction in coin supply by 50 percent after even halving event may make the coins deflationary due to the limit on how many coins may be mined and produced. Further, once the limit of 21 millions may be reached, no more coins may be mined and this scarcity will make it harder to obtain the coins. It may be noted that the pre-defined number of blocks and the coin limits may be other than the aforementioned numbers, without departing from the scope of the invention and based on the requirements of the business. Thus, increasing the value of the coins since the user holding the coins may ask for increased prices of the coins.

In an embodiment of the present invention, the conventional crypto-coins difficulty factor forces them to a roughly four-year period before reducing the mined coin release for each block by 50% “Half.” Over those four years, they complete 210,000 blocks and release 50% of its total supply of coins by the first Halving and 50% of what is left after its second halving. As a result, conventional crypto-coins have an average of approximately 2,020 Transactions per block and, times 210,000 Blocks, will complete approximately 424.2 Million transactions per Halving Event. Below table shows the comparison halving table:

| Compare Halvings | Bitcoin | PoAM Crypto-Coin |
|---|---|---|
| Coin Supply capped at | 21,000,000 | 21,000,000 |
| Smallest Unit | 0.00000001 (8 decimal) | 0.000001 (6 decimal) |
| Smallest Unit Name | Satoshi | Acts |
| Block releases the coin | Yes | Yes |
| Transactions to complete a Block | ~2,020 | 2,100=1 Block |
| Halving Event | 210,000 | 100 Blocks=210,000 |
| Total Halving Events | 32 | 26 |
| Total Blocks | 6.72 million | 2600 |
| Time to complete all Mining | ~128 years | ~6 to 10 years |
| Complete 93.55% Mining | 4^{th} Halving Event | 4^{th} Halving Event |
| Time to Complete 4 Halvings | ~16 years (2024) | ~3 years (2025) |
| Coin Mined/Block before 1^{st} Halving | 50BTC | 105,000 TRQ |
| Coins Mined Per Transaction | N/A | 50TRQ |
| Each Halving Reduces Coin | 50% | 50% |
| Mining Model | Proof-of-Work | Proof-of-Activity-Mining |
| Pre-mined Coin | 0% | Block 0001-000?^{∗} |

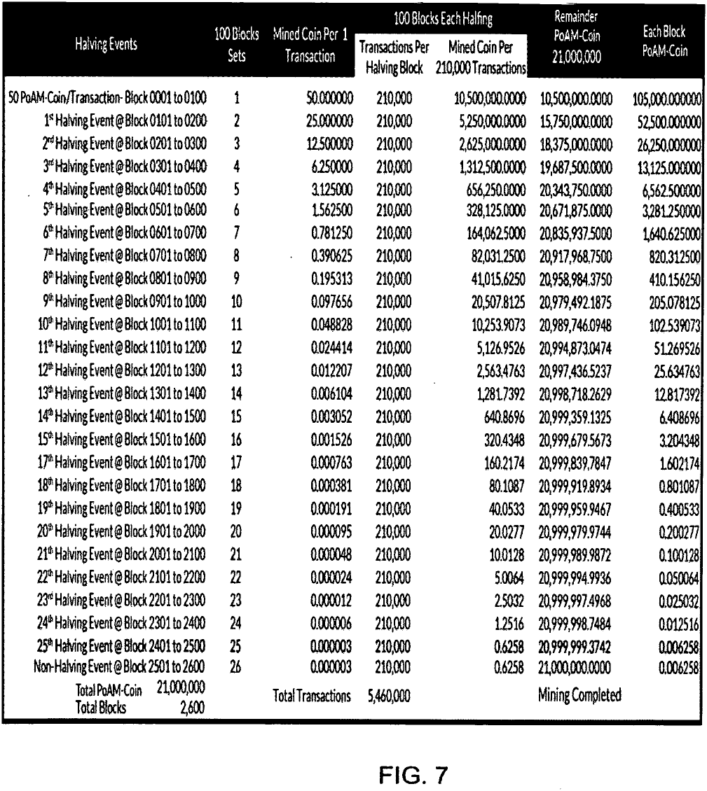

Further, the crypto-coins mining disbursement halving chart is shown in table as given at FIG. 7.

Further, the system 100 based on the PoAM model may not be concerned about the rate at which a block is completed as a factor of time but may be concerned with the sales volume change from one block to the next. This may promote an increase in positive activities that may be the driving forces that may increase the volume and the system 100 target completion of the block as soon as possible. Further, the system 100 may be concerned with the sales volume ratio between business product sales and coin sales to create a balance that may create more coin value. Further, the balance may not be about equal transactions or volume between the Product Sales and the Coin Sales the one that may create the most value in the coin. In an embodiment of the present invention, it may be 25/75, 30/70, 65/35, or any ratio that promotes the most value of the coin.

The disclosed embodiments encompass numerous advantages. Various embodiments of a system 100 for mining crypto-coins have been disclosed. Thus, the disclosed system 100 for mining crypto-coins allows effective mining of the crypto-coins. Further, the disclosed crypto-coins have high utility, high scarcity and high perceived value. The disclosed system 100 to mine crypto-coins is transactions based and provides a better valuation of the business. Further, the disclosed system 100 halves the number of crypto-coins per block after 100 block mining to increase scarcity of coins in the market. The disclosed system 100 allows the miners to hold the coins in the wallet allows increase in the value of the coins. Therefore, the disclosed system 100 for mining crypto-coins allows high value of the crypto-coins in the market.

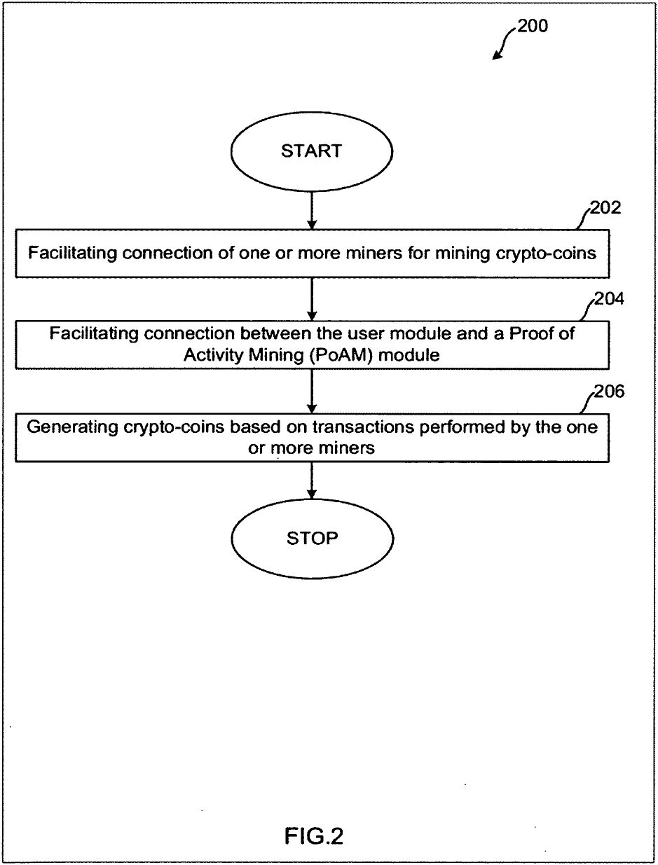

FIG. 2 illustrates a flow chart of a method for mining crypto-coins in accordance with an embodiment of the present invention. At first, a connection of one or more miners may be facilitated for mining crypto-coins, at step 202. Next, a communication between the user module and a Proof of Activity Mining (PoAM) module may be facilitated, at step 204. Then, crypto-coins may be generated, at step 206. The crypto-coins may be generated based on transactions performed by the one or more miners.

In an embodiment of the present invention, the generation of the crypto-coins may be performed by allowing mining of a pre-defined number of crypto-coins per transaction. Then, allowing mining of a block after a pre-defined number of transactions. Next, determining a percentage of mined crypto-coins associated with one or more miners per mined block. Thereafter, halving at least one of: a number of coins per block and a number of coins per transaction after a pre-defined number of blocks are mined.

In an embodiment of the present invention, the method may include storing at least one of: the unmined crypto-coins and information associated with the mined crypto-coins in a database. In an embodiment of the present invention, the total number of crypto-coins are 21000000. In an embodiment of the present invention, the number of coins may vary depending on the business the PoAM may be used for.

In an embodiment of the present invention, the method may include moving 5 percent swing per block of the mined coins from the miner side to the operation side and back again based on an activity factor. Further, the activity factor is determined by change of the volumes ratios between the product sales and the coin sales of the previous block to the current block. It may be noted that the percent of swing per block may be other than 5 without departing from the scope of the invention.

In an embodiment of the present invention, the method may include facilitating the miner to hold the mined coins and return staking points and multiply the staking points by at least two multipliers count-multi and stake-multi. Also, the method may include hosting the crypto-coins for the one or more miners via a blockchain network.

In an embodiment of the present invention, the pre-defined number of crypto-coins per transactions are 50 crypto-coins. Further, the pre-defined number of transactions are 2100 transactions. Furthermore, the pre-defined number of blocks are 100 blocks. In an embodiment of the present invention, applied for 1 coin from the business such that premined coins when applied to other coins may not have premined coins. In an embodiment of the present invention, the pre-defined number of crypto-coins per transactions, pre-defined number of transactions and pre-defined number of blocks may be different from the aforementioned numbers without departing from the scope of the invention and based on the requirements of the business.

In an embodiment of the present invention, the disclosed mechanism may connect the real world product sales business to a crypto-coin. The PoAM crypto-coin using 21 million coins is part of the perceived value through mirroring conventional crypto-coins but other disclosed Crypto Coins may use other amounts of limited coins but there can also be not tied to the disclosed model. In an embodiment of the present invention, the number of coins may vary depending on the business the PoAM may be used for. The important part is the Activity represented as points. Further, the disclosed Crypto-Coins aim to have its market value reflect the value of the business activity and Crypto-Coin value will reflect all the Activities and mirror the value of the business activity by creating coins. Thus, the value of the coins on the market creates links to sales of physical products and the swap of coins on crypto markets. The disclosed Crypto-Coin models goal is to create a cryptocurrency that uses the growth of business’s product sales to measure its value, which reflects in the markets. Further, the only difference may be that the conventional crypto-coins completes a Block by solving a math problem and the disclosed Crypto-Coin uses the number of transactions of real world product sales that are recorded on the blockchain as a transaction to complete the mining of the block. The disclosed embodiments encompass numerous advantages. Various embodiments of a method for mining crypto-coins have been disclosed. Thus, the disclosed method for mining crypto-coins allows effective mining of the crypto-coins. Further, the disclosed crypto-coins have high utility, high scarcity and high perceived value. The disclosed method to mine crypto-coins is transactions based and provides a better valuation of the business. Further, the disclosed method halves the number of crypto-coins per block after 100 block mining to increase scarcity of coins in the market. It may be noted that the disclosed method may half the number of crypto-coins per block after any number of block mining without departing from the scope of the invention. The disclosed method allows the miners to hold the coins in the wallet allows increase in the value of the coins. Therefore, the disclosed method for mining crypto-coins allows high value of the crypto-coins in the market.

It has thus been seen that the mechanism for mining crypto-coins according to the present invention achieves the purposes highlighted earlier. The system for mining crypto-coins can in any case undergo numerous modifications and variants, all of which are covered by the same innovative concept; moreover, all of the details can be replaced by technically equivalent elements. In practice, the materials used, as well as the shapes and sizes, can be whatever according to the technical requirements. The scope of protection of the invention is therefore defined by the attached claims.

What is claimed is:

1. A system for mining crypto-coins, the system comprising:
a user module to facilitate connection of one or more miners for mining crypto-coins;
a blockchain network to facilitate communication between the user module and a Proof of Activity Mining (PoAM) module;
the PoAM module to generate crypto-coins based activities performed by the one or more miners that add to the total, the PoAM module comprising:
a transaction module to allow mining of a pre-defined number of crypto-coins per transaction;
a block module to allow mining of a block after a pre-defined number of transactions;
a miners percentage module to determine a percentage of mined crypto-coins associated the one or more miners per mined block;
a halving module configured to half at least one of: a number of coins per block and a number of coins per transaction after a pre-defined number of blocks are mined.

2. The system as claimed in claim 1, further comprises a database communicatively coupled to the PoAM module and configured to store at least one of: the unmined crypto-coins and information associated with the mined crypto-coins.

3. The system as claimed in claim 1, wherein the total number of crypto-coins are 21000000.

4. The system as claimed in claim 1, wherein the PoAM module further comprises:
an activity factor module is configured to move 5 percent swing per block of the mined coins from the miner side to the operation side and back again based on an activity factor; and
a wallet staking module is configured to facilitate the miner to hold the mined coins and return staking points and multiply the staking points by at least two multipliers count-multi and stake-multi.

5. The system as claimed in claim 4, wherein the activity factor is determined by change of the volumes ratios between the product sales and the coin sales of the previous block to the current block.

6. The system as claimed in claim 1, wherein the blockchain network is further configured to host the crypto-coins for the one or more miners.

7. The system as claimed in claim 1, wherein the pre-defined number of crypto-coins per transactions are 50 crypto-coins.

8. The system as claimed in claim 1, wherein the pre-defined number of transactions are 2100 transactions.

9. The system as claimed in claim 1, wherein the pre-defined number of blocks are 100 blocks.

10. The system as claimed in claim 1, applied for 1 coin from the business such that premined coins when applied to other coins may not have premined coins.

11. A method for mining crypto-coins, the method comprising:
facilitating connection of one or more miners for mining crypto-coins;
facilitating communication between the user module and a Proof of Activity Mining (PoAM) module,
generating crypto-coins based on activities performed by the one or more miners that add to the total, wherein the generation of crypto-coins is performed by:
allowing mining of a pre-defined number of crypto-coins per transaction;
allowing mining of a block after a pre-defined number of transactions;
determining a percentage of mined crypto-coins associated with one or more miners per mined block;
halving at least one of: a number of coins per block and a number of coins per transaction after a pre-defined number of blocks are mined.

12. The method as claimed in claim 11, further comprises storing at least one of: the unmined crypto-coins and information associated with the mined crypto-coins in a database.

13. The method as claimed in claim 11, wherein the total number of crypto-coins are 21000000.

14. The method as claimed in claim 11, further comprises:
moving 5 percent swing per block of the mined coins from the miner side to the operation side and back again based on an activity factor; and
facilitating the miner to hold the mined coins and return staking points and multiply the staking points by at least two multipliers count-multi and stake-multi.

15. The method as claimed in claim 14, wherein the activity factor is determined by change of the volumes ratios between the product sales and the coin sales of the previous block to the current block.

16. The method as claimed in claim 11, further comprises hosting the crypto-coins for the one or more miners via a blockchain network.

17. The method as claimed in claim 11, wherein the pre-defined number of crypto-coins per transactions are 50 crypto-coins.

18. The method as claimed in claim 11, wherein the pre-defined number of transactions are 2100 transactions.

19. The method as claimed in claim 11, wherein the pre-defined number of blocks are 100 blocks.

20. The method as claimed in claim 11, applied for 1 coin from the business such that premined coins when applied to other coins may not have premined coins.
